(19) United States
(12) Patent Application Publication
(10) Pub. No.: US 2010/0266326 A1
(43) Pub. Date: Oct. 21, 2010

(54) MARK-ERASABLE PEN CAP

(76) Inventor: Cheng-Hua Chuang, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/427,166

(22) Filed: Apr. 21, 2009

(51) Int. Cl. B43K 23/00; B43L 19/00

(52) U.S. Cl. 401/98; 15/425

(57) ABSTRACT

A mark-erasable pen cap comprises a cap body having a containing groove. The cap body is made of an elastic erasing material and defines a first end and an opposing second end. The first end has an opening. The containing groove comprises a bottom portion, an opening portion, and a wall portion. The bottom portion neighboring to the first end has a first diameter; the opening portion located at the second end has a second diameter smaller than the first diameter; and the wall portion connecting the bottom portion and the opening portion has an inner diameter substantially tapered from the opening portion to the bottom portion.

### BACKGROUND OF THE INVENTION

(1) Field of the Invention

The present invention relates to a pen cap, more particularly to a mark-erasable pen cap.

(2) Description of the Prior Art

Erasers for erasing undesired marks are necessary in writing. In the art, a combination of a writing instrument and an eraser is usually suggested, for example, by attaching an eraser to a pencil. However, such an eraser is generally rather small and is therefore used up quickly.

According to U.S. utility Pat. No. 5,709,491, a pencil-like eraser is disclosed to include a tubular eraser to sleeve an ink reservoir of a ball-point pen by having a ball point of the ball-point pen extend out of the tubular eraser. When a user uses the pencil-like eraser to write, he or she may use the tubular eraser to erase undesired marks.

However, the cambered surface of the tubular eraser is not convenient for erasing. The pencil-like eraser is also restricted to accommodate a certain type of ink reservoir. Namely, the tubular eraser cannot be applied to most of writing instruments in the market.

Moreover, another conventional pen cap is found to have a rigid cap body further capped by a tiny eraser. Such a design exists the same restriction in accommodating only a small group of writing instruments.

### SUMMARY OF THE INVENTION

Therefore, the primary object of the present invention is to provide a mark-erasable pen cap to include a cap body and a containing groove therein. The cap body defining a first end and an opposing second end is made of an elastic erasing material to provide more mass available for erasing. The containing groove has a bottom portion, an opening portion and a wall portion. The wall portion connects the bottom portion and the opening portion and is formed to have the diameter of the containing groove varied in a taper pattern from the bottom portion to the opening portion. As a result, the containing groove can receive various sizes of writing instruments.

In one embodiment of the present invention, the mark-erasable pen cap further has an opening in the first end of the cap body. When someone swallows accidentally the mark-erasable pen cap, the opening can let him or her breathe consistently.

In present invention, the elastic erasing material can be a rubber material, a chemical eraser compound, or any eraser material the like.

In one embodiment of the present invention, the first end can be a cone structure with relevant varying cross sections.

In one embodiment of the present invention, the wall portion can further include a threaded interior for fastening the writing instrument thereinside stably.

All these objects are achieved by the mark-erasable pen cap described below.

### BRIEF DESCRIPTION OF THE DRAWINGS

Other features and advantages of this invention will become more apparent in the following detailed description of the preferred embodiment of this invention, with reference to the accompanying drawings, in which:

FIG. 1 is a perspective view of a preferred mark-erasable pen cap of the present invention and a portion of a writing instrument to be capped by the mark-erasable pen cap;

FIG. 2 is a schematic view demonstrating a situation that the mark-erasable pen cap of FIG. 1 is accidentally swallowed and chokes a throat;

FIG. 3 is a cross-sectional view of FIG. 1 along line AA;

FIG. 4 shows the mark-erasable pen cap of FIG. 1 applied to a writing instrument;

FIG. 5 shows the mark-erasable pen cap of FIG. 1 applied to another writing instrument; and

FIG. 6 is a cross-sectional view of a second embodiment of the mark-erasable pen cap in accordance with the present invention.

### DETAILED DESCRIPTION OF THE PREFERRED EMBODIMENT

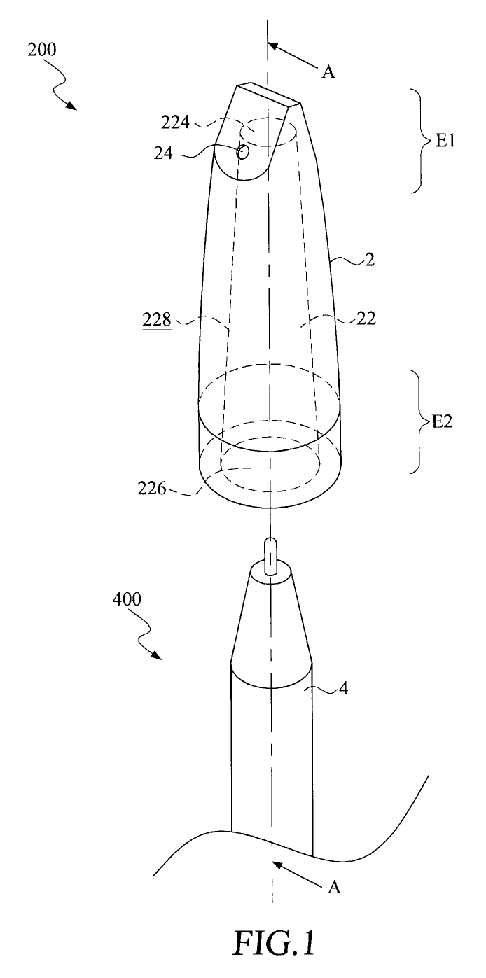

FIG. 1 shows a perspective view of a preferred mark-erasable pen cap 200 of the present invention and a writing instrument 400 to be capped by the pen cap 200, in which the pen cap 200 includes a cap body 2 having a containing groove 22 to receive an end 4 of a writing instrument 400 (such as a pencil or a pen). The pen cap 200 for erasing undesired mark can be made of an elastic erasing material; preferably, a rubber material.

By providing the pen cap 200 of the present invention, the user doesn't have to buy another eraser, and also the application of the pen cap 200 to accompany with the writing instrument 400 can avoid an embarrassing situation of missing an eraser while in urgent need. Due to the elastic material it uses, the mark-erasable pen cap 200 can match up the variety sizes of writing instruments 400. Therefore, advantages in convenience from combining eraser and writing instrument 400 and in prevention from missing an eraser can be both achieved.

As shown in FIG. 1, the two ends of the cap body 2 are defined as a first end E1 and a second end E2. The first end E1 can be a taper structure in a proper cross-section, preferably a trapezoid cross section. In the present invention, the taper structure can be a top-off cone structure, a cylinder structure with both sides wedgewise cut off (as shown so as to form a trapezoid cross section), and any structure the like. Particularly, the diameter of the taper structure at the first end E1 is gradually decreased along a longitudinal direction toward the tip of the pen cap 200. Upon such an arrangement, the pen cap 200 can be easily applied to erase tiny marks.

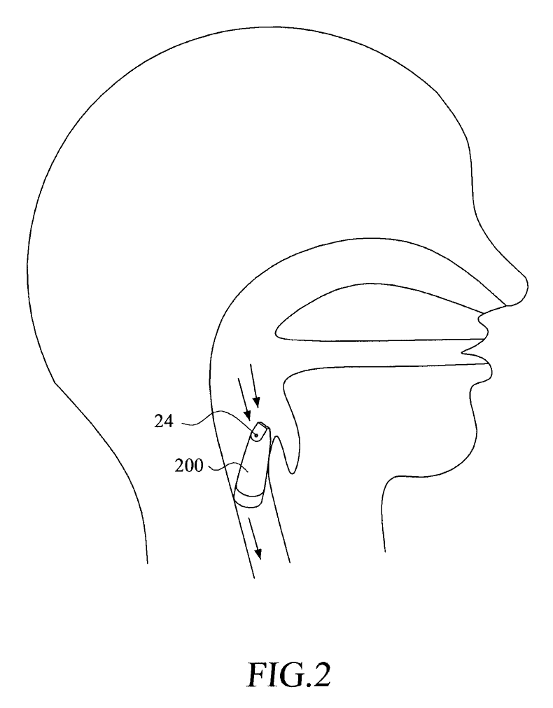

Further, in the present invention, the first end E1 can have an opening 24 for air-communication between the containing groove 22 and the atmosphere around the first end E1. Upon such an arrangement, an accidental choking or even a fatal asphyxia while in a mistake swallow can be avoided by an air passage constructed through the opening 24, as shown in FIG. 2.

Referring back to FIG. 1, the containing groove 22 includes a bottom portion 224, an opening portion 226 and a wall portion 228. The bottom portion 224 is located in the first end E1, and the opening portion 226 is located in the second end E2. The wall portion 228 connects the bottom portion 224 and the opening portion 226 so as to form the containing groove 22. The opening portion 226 has an opening to allow a tip end 4 of a foreign writing instrument 400 to plug into the containing groove 22 at the second end E2.

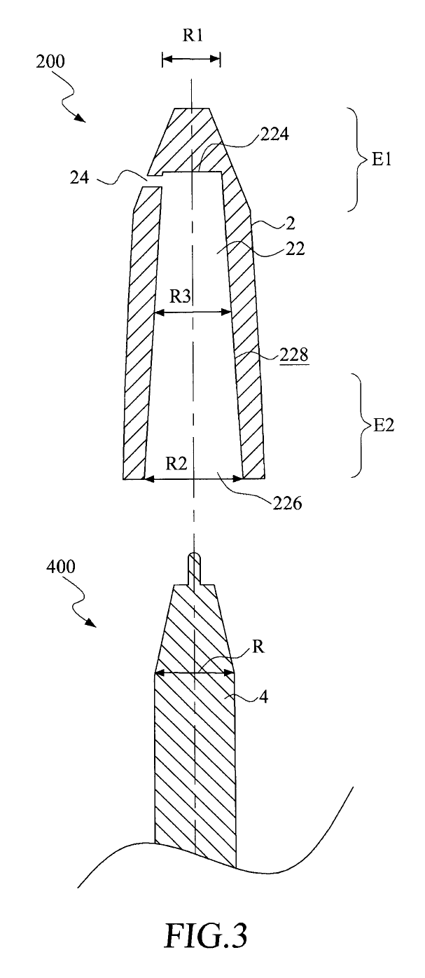

Referring now to FIG. 3, it is the cross-sectional view of FIG. 1 along line AA. As shown, the bottom portion 224 has a first diameter R1; the opening portion 226 has diameter R2; the wall portion 228 has an inner diameter R3; and the end 4 of the writing instrument 400 has a tube diameter R.

As shown in FIG. 3, preferably, the inner diameter R3 substantially increases from the first diameter R1 to the second diameter R2. In practice, containing groove 22 is progressively narrowed so as to receive variety sizes of wiring instruments 400.

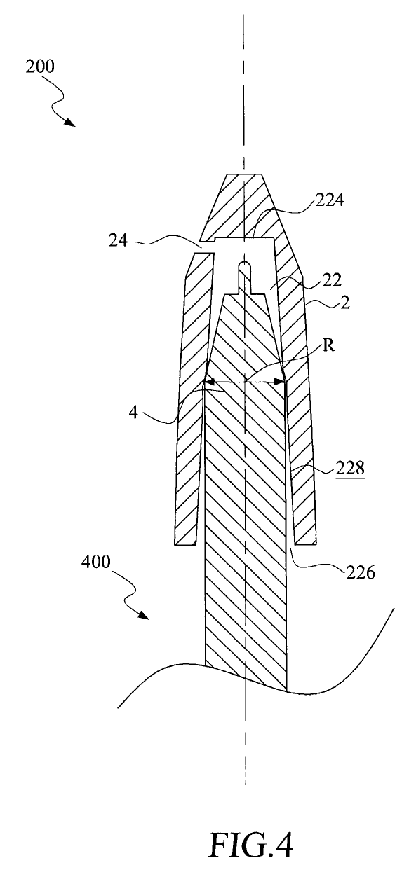

As shown in FIG. 4, the tube diameter R of the writing instrument 400 is smaller than the second diameter R2, but bigger than the first diameter R1. Thereby, the end 4 can pass through the opening portion 226 and be nested within the containing groove 22.

Meanwhile, as a result of the elastic material used for the shell structure of the cap body 2, a slight pull may stretch and shrink the opening portion 226 so as to hold the writing instrument 400 firmly inside the mark-erasable pen cap 200.

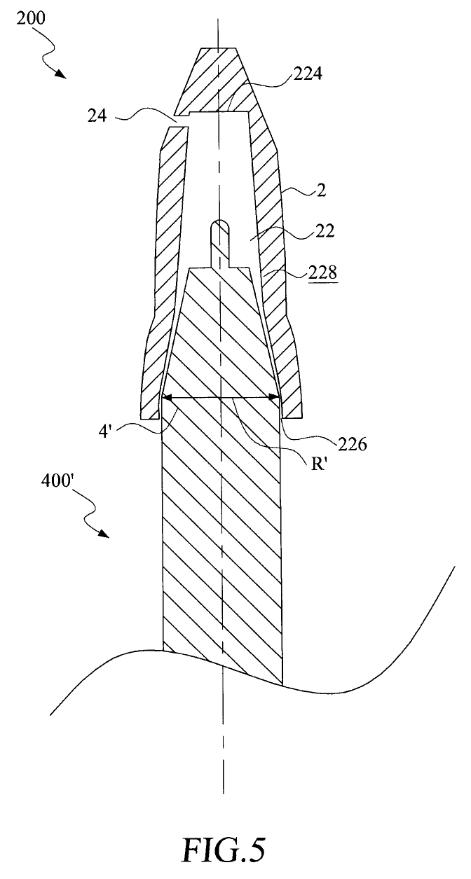

As shown in FIG. 5, even when the tube diameter R′ of the writing instrument 400′ is slightly bigger than second diameter R2, the user can still expand elastically the opening portion 226 so as to hold tightly the end 4′.

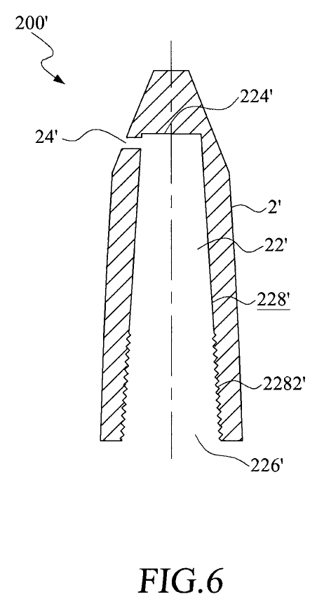

As shown in FIG. 6, in a second embodiment of the mark-erasable pen cap in accordance with the present invention, the wall portion 228′ further has a threaded surface (interior wall) to help fastening the writing instrument 400 inside the containing groove 22.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A mark-erasable pen cap being applied to receive an end of a writing instrument therein, comprising:
a cap body made of an elastic erasing material defining a first end and a second end having a containing groove with a containing space to receive the end of the writing instrument therein, said containing grove further comprising:
a bottom portion neighboring to the first end and having a first diameter;
an opening portion neighboring to the second end and having a second diameter; and
a wall portion connecting with the bottom portion and the opening portion, having an inner diameter substantially enlarged from the first diameter to the second diameter.

2. The mark-erasable pen cap according to claim 1, wherein said elastic erasing material is a rubber material.

3. The mark-erasable pen cap according to claim 1, wherein said cap body has an opening neighboring to the first end.

4. The mark-erasable pen cap according to claim 1, wherein said first end is a structure with a trapezoid cross-section.

5. The mark-erasable pen cap according to claim 1, wherein said wall portion has an interior threaded surface.
